(19) United States
(12) Patent Application Publication
(10) Pub. No.: US 2004/0125921 A1
(43) Pub. Date: Jul. 1, 2004

(54) Method to determine the optimal parameters of a radiography acquisition

(76) Inventors: Cyril Allouche, Montfort L'Amaury (FR); Lionel Desponds, Saint Remy les Chevreuse (FR); Philippe G. Ballesio, Limours (FR); Francois Serge Nicolas, Gif Sur Yvette (FR)

Correspondence Address: Jay L. Chaskin, Cantor Colburn LLP, 55 Griffin Road South, Bloomfield, CT, 06002, US

(21) Appl. No.: 10/684,894

(22) Filed: Oct. 14, 2003

(30) Foreign Application Priority Data
Oct. 29, 2002 (FR) 02 13565

(51) Int. Cl. G01D 18/00

(52) U.S. Cl. 378/207; 382/132

(57) ABSTRACT

To make the settings for an X-ray installation, so that the images that it reveals have the greatest possible contrast, a measurement is made of a mean equivalent thickness of the body of a patient being examined from a test image. However, as a preliminary, the test image is rid of those pixels for which it is known, a priori, that their significance does not comprise any interesting gray levels. The dynamic range of the image can be set objectively by choosing the thickness threshold and the equivalent mean thickness as a given proportion of the dynamic range. Preferably, the computation and the setting are done on the fly, in real time after the acquisition of the test image.

### CROSS-REFERENCE TO RELATED APPLICATIONS

This application claims the benefit of a priority under 35 USC 119(a)-(d) to French Patent Application No. 0213565 filed Oct. 29, 2002, the entire contents of which are hereby incorporated by reference.

### BACKGROUND OF THE INVENTION

This invention and embodiments thereof is directed to a method for determining the optimal parameters of a radiography or X-ray acquisition.

An X-ray installation commonly requires the accurate estimation of appropriate exposure parameters, essentially the high voltage kVp, the integral of the throughput current mAs, and the filtering capacity of the interposed filters, so as to provide the optimal penetration of the radiation into the object, such as tissues, being examined and good image quality. These parameters commonly depend physically on the radiological thickness of the regions being imaged. An object, such as a patient's body, shows a distribution of thicknesses, expressed in terms of equivalent thicknesses, with respect to each of the pixels of a detector of the installation. The body may furthermore be represented by a mean thickness, known as the mean EPT (Equivalent Patient Thickness). This distribution is even more efficiently represented by the patient's dynamic range, referenced ΔEPT, which corresponds to the variation in the equivalent thickness of the tissues of interest.

In installations, only the mean EPT has been taken into consideration. In the early stages of radiology, the mean equivalent patient thickness, or mean EPT, was deduced from the weight of the patient. Subsequently, the mean thickness was measured more realistically by taking a test image of the patient, under arbitrary given conditions of operation of the radiology installation, and by measuring characteristics of pixels representing the mean thickness in the test image thus taken. To get a clear picture, and although this is not a limitation of the invention, mean thicknesses of 4 or 5 cm to about 40 cm could be measured in this way. The patient's dynamic range ΔEPT, it was not measured. It was arbitrarily set at a value that could range between a few cm and about 20 cm. The patient dynamic range was left to the practitioner, who used it to set the contrast of the revealed images in the way that suited him/her best. Thus, the setting was subjective and not objective.

The dynamic range, in terms of thickness of a patient's body, is the variation observed, in the patient's regions of interest, between the smallest equivalent thicknesses and the greatest equivalent thicknesses. For example, for a dynamic range in thickness, starting from a minimum thickness (of about 3 cm) it is possible to go up to a maximum thickness whose size will often be greater or smaller depending on the tissues to be imaged in the patient. For example, a useful dynamic range of 5 cm in thickness is encountered in the region of a patient's abdomen (where there is little differentiation between the tissues in terms of radiological density) whereas in other regions of the patient's body, there is a greater dynamic range, for example equal to 14 cm. The dynamic range of measurement must be adapted respectively from 3 to 3+5=8 cm in the former case or from 3 to 3+14=17 cm in the latter case. If a default value of dynamic range typically corresponding to 14 cm in thickness is chosen, and if this setting of the installation is used to measure a region of a patient's abdomen, then much is lost in terms of image contrast, sensitivity of detection and revelation, since the useful signal for the abdomen will be revealed only with a dynamic range of 5/14th of what would be possible.

The drawback of these methods is that the contrast of the images shown is therefore always sub-optimal. Indeed, especially in the context of X-ray images of the pelvis, no mechanism is implemented to reject regions of saturation, and also zones known as non-anatomical regions. This leads to erroneous estimates of the mean equivalent patient thickness, or mean EPT. In addition, the absence of a device to eliminate saturation radiation forces the user to use contour filters, and to position the patients in a strictly precise way. This is not especially easy when the image has to reveal angiographies near the bottom of the lungs.

The dynamic range cannot be estimated. This leads to a sub-optimal management of the doses and to defective quality. In other cases, a faulty setting of the dynamic range may lead to aberrations of saturation in certain images: an interesting part of the image will be in a saturated zone. In other cases, the poor contrast or excessively dark images may give rise to a contrast-to-noise ratio of less than 30% of an optimal level of contrast.

### BRIEF DESCRIPTION OF THE INVENTION

The invention and embodiments thereof is a method to determine the optimal parameters of a radiography acquisition comprising:

a. a first test image of an object is acquired under known setting conditions for a radiography installation;

b. a mean thickness of the object is measured, for these known setting conditions, from the first test image test;

c. the optimal parameters of acquisition are determined from the mean thickness; and

d. a measure is made of the mean thickness from the first test image, where pixels that do not represent significant parts of the object are excluded from the first test image.

### BRIEF DESCRIPTION OF THE DRAWINGS

The invention and embodiments thereof will be understood more clearly from the following description and the accompanying figures. These figures are given purely by way of an indication and in no way restrict the scope of the invention. Of these figures:

FIG. 1 is a schematic composite view of the phenomenon of irradiation and in the prior art and in the invention, respectively;

FIG. 2 is a schematic view of a part of an object, such as a patient's body, in which different regions are shown: regions of interest and regions of little interest;

FIG. 3 shows a sequence of steps implemented an embodiment of the method for setting an radiography installation; and

FIG. 4 is a histogram of pixels of the image taken.

### DETAILED DESCRIPTION OF THE INVENTION

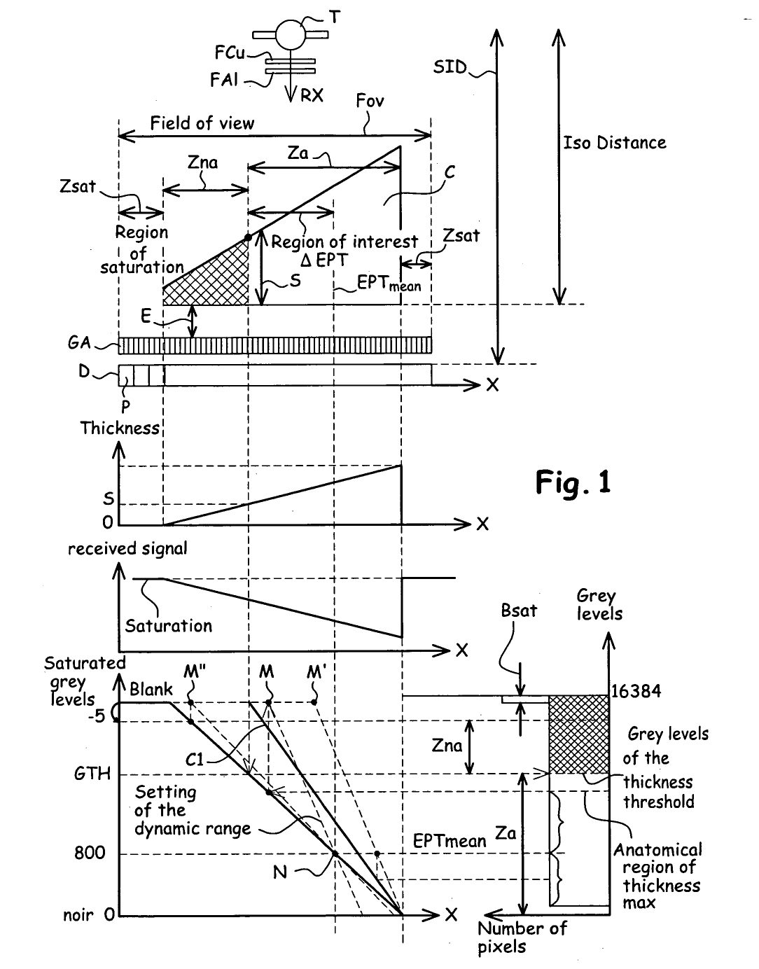

FIG. 1 is a schematic view, particularly in its upper part, of a radiography, such as X-ray, installation. The installation comprises a means for providing radiation, such as an X-ray tube T, sending out X-rays RX toward an object, such as a patient's body C. The body C is shown as having a triangular profile. This depiction is quite artificial but will provide for a simpler explanation. Of course, the patient's body has a rather oval shape or even a rectangular shape in a section examined. The X-rays emitted by the tube T are traditionally filtered by filters formed by copper strips FCu and by aluminum strips FAl. These filters ensure that the spectral density of the X-rays is confined within a relatively narrow passband. The filtering capacity of these filters naturally plays a part in the setting of the apparatus, and it is possible to install different filters as required.

Below a patient-support plate (not shown) there is an anti-scatter grid GA superimposed on a detector D. In practice, the grid GA comprises a certain number of septal walls ensuring that the radiation that crosses it is solely (in theory) X-radiation coming directly from the tube T. However, since the grid GA carries out an absorption, its thickness is reduced. This reduces the efficiency with which the Compton scattering is picked up, forming a scattered radiation that is sought to be eliminated. The detector D furthermore comprises a set of elements for the detection of an image signal corresponding to pixels P. In practice, the detector D is an electronic detector. Hereinafter in the explanation, the pixels shall be identified with the signal delivered by the detector elements located at their position. However, it is also possible to envisage the digitizing of an image acquired on a film.

FIG. 1 shows the body C, in a direction X and a direction in thickness, or height. However, detector D as well as the anti-scatter grid GA is 2D elements. The detector D as well as the grade GA defines a field of view FOV. This field of view FOV extends over saturation zones Zsat as well as body regions, pertaining to the body C that will be separated into anatomical regions Za and non-anatomical regions Zna.

The first graph of FIG. 1 shows a corresponding view, below this schematic installation, of a thickness of the patient's body C as a function of the abscissa X. The thickness starts from zero at the boundary between the saturation region Zsat to the left and the non-anatomical region Zna and increases up to the maximum thickness, at the extremity located to the right of the body C. The thickness graph here in both a graph of true thickness and a graph of equivalent thickness. The one will be deducted from the other by a simple homothetic approach.

The equivalent thicknesses are thicknesses of human tissues given by their equivalents in thicknesses of plastic materials of a quality known according to the standards.

The graph located beneath the thickness graph gives a view, for this thickness, of the signal received by the detector D. In the saturation regions Zsat, the detector is, in effect, normally saturated since no issue has been interposed in the path of the X-rays. The detector measures a level of energy received that depends on the penetrative force of the rays (namely, the hardness of the X-rays) and the duration of the pose or simply on the value given by the milliamperes multiplied by the seconds of this pose. The received signal decreases in a manner corresponding to the thickness of the body C that the X-rays have to cross. It is shown here artificially that the decrease is linear with the thickness. However, this is not true in theory and in practice owing to an exponential type of absorption. However, this simplistic representation provides for a better explanation of the invention.

If the installation, for known setting conditions, is not too poorly set for the maximum thickness of the body C, the quantity of energy received for the pixels to the right, concerned by this maximum thickness, will not be zero. Otherwise, there will be a phenomenon of clipping from the base, and the conditions of acquisition of the test image from which all the measurements would be made will be slightly falsified. Naturally, beyond, to the right of the edge of the body C, the received signal also corresponds to a saturation signal.

The detector D or any other equivalent imaging system, including the digitization of an image revealed on an X-ray film, possesses a dynamic range of revelation. In practice, at the position of each pixel, the energy received is measured by sampling counters for which the number of counting positions is limited. In a non-restrictive example, 14-position counters have been chosen so that the signal delivered by these counters can only be between 0 and 214-1 namely, between 0 and 16383 (or 16384 if we overlook the −1). A first simple setting of the dynamic range of the detector may lie in setting a maximum gray level, corresponding to the blank parts of the image, for regions of the body at the boundary of the saturated region to the left, and a gray level 0, corresponding to the black, for the greatest thickness of the body C. Between these two values, in this case artificially, it has been shown that the signal evolves as a function of the abscissa X linearly in passing from 16384 to 0 from one edge of the body C to the other.

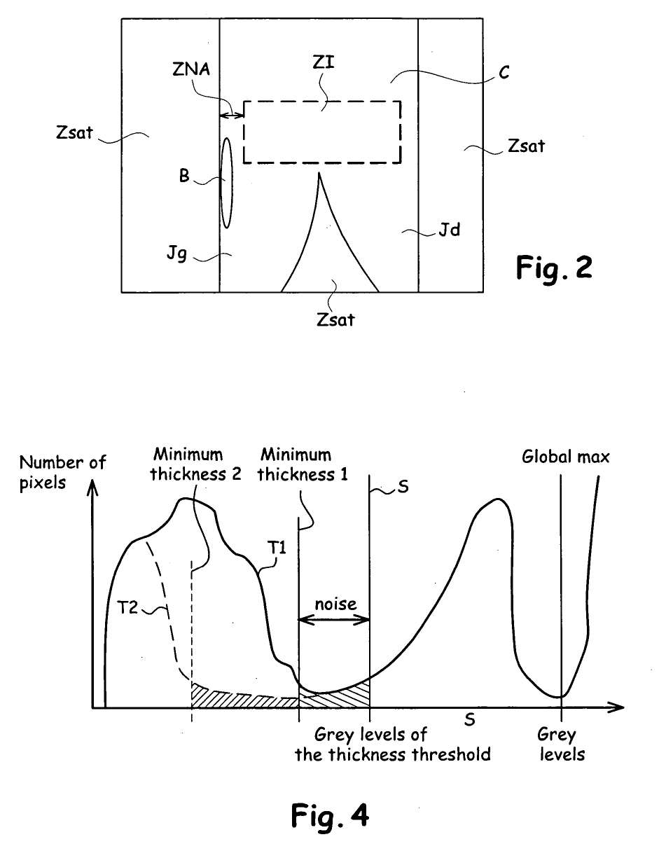

The above describes the acquisition of a first test image for known conditions of setting of the installation. For example, this image may be the one shown in FIG. 2 giving a very schematic view of a patient's pelvis. In this image, to the right and left of the legs Jd and Jg as well as between these legs, there are saturation regions Zsat. The mean EPT, namely the mean thickness of the patient's body C was measured by taking account both of the regions representing the body C and of the saturation regions. An embodiment of the invention in particular will eliminate the saturation regions, but not solely or not exclusively these regions.

If, in particular, it is determined that the region of interest ZI, herein demarcated by dashes, corresponds to an abdominal part of the patient's body, it will be worthwhile to increase the contrast in this region of interest. It will also be noted that the problem of contrast is particularly difficult to resolve for the abdominal regions, where there is in fact little differentiation between the tissues and where, naturally, the contrast is not very good.

In the regions known as non-anatomical regions, typically represented by the edges B of the patient's body C, there is no image information to be sought. Hence, to compute the mean thickness representing the truly useful conditions of acquisition, it desired to eliminate both the saturation regions and the non-anatomical regions.

FIG. 1 gives a schematic view, on the thickness graph, namely the second graph, of a thickness threshold S below which it is considered that the regions of the body examined are non-anatomical regions. Described below, is how the threshold S is determined. However, with threshold S being known, it is possible, under the conditions of acquisition of the test image being studied, to determine which gray level this thickness threshold S corresponds. The reference GTH denotes the gray level threshold. It is also possible to compute its equivalent in terms of received dose. To then compute the mean value, the mean EPT, a histogram is made of the gray level values of the pixels of the image. In practice, since the body C has very artificially been given a triangular profile, and in not considering the exponential measurement, the histogram takes the form of a constant number of pixels, whatever the gray level (see the graph at the bottom, right-hand part of FIG. 1). For the saturation regions, the histogram comprises a very large number of pixels revealing a saturated signal, gray levels higher than a saturation level, schematically indicated at 16384 in the example. FIG. I furthermore has a hatched zone above the gray level corresponding to the thickness threshold S.

An embodiment of the invention comprises computing the mean thickness, mean EPT, for the right candidate pixels only, namely for the pixels located to the right of the thickness threshold at the top of FIG. 1, and located below the corresponding gray level in the histogram. The population of the histogram thus reduced then enables the computation of a mean thickness.

In practice, the gray levels reveal the doses received. According to the formula I=Io exp (−μx), these doses reveal that the received radiation level varies exponentially as a function of the thickness (x). To compute the mean thickness, it is therefore desirable to convert the histogram of gray levels into a histogram of equivalent thicknesses S, using the logarithm of the gray levels (or the logarithm of the doses received if the histogram is being done for doses). With the equivalent thicknesses and with the number of their occurrences, the mean thickness is computed.

This is shown schematically as corresponding to an intermediate position between the gray level of the thickness threshold and the gray level of the maximum thickness. The mean thickness is thus computed far more precisely (and as described below how this computation can itself be further improved). The mean thickness is used in a known way to set the radiography installation. It is enough to use this mean thickness in path software. Path software of this kind comprises means to determine the setting parameters of the installation, as a function particularly of a mean thickness mean EPT, a dynamic range ΔEPT, a desired number of views, and the temperature of the tube T at the time of the examination. The path computation makes it possible to set the installation in a manner best suited to the user's wishes so that the tube, at the end of the experiment, does not attain temperature values leading to its deterioration. Path software programs are known and specific to each installation.

In an embodiment of the invention, the dynamic range is also computed. It can be assumed that the setting conditions dictated solely by knowledge of the mean thickness will correspond to those of a decrease in the gray levels, from the zero thicknesses to the greatest thicknesses, as shown in the curve C1 of FIG. 1. On the other hand, in an embodiment of the invention the dynamic range will also be set. The thickness is set in such a way that the mean thickness, mean EPT, corresponds to a given proportion of the dynamic range in terms of gray levels of signal, or doses if the work is being done in doses. To this end firstly, by way of an improvement, rather than choosing a thickness threshold S as explained hitherto, a threshold known as a maximum anatomical threshold will be chosen corresponding to an interesting maximum anatomical region. The gray level of the maximum anatomical threshold is lower than the thickness threshold. The installation is then set so that the detector delivers a maximum signal, corresponding to 16384 gray levels in the example, for the thicknesses corresponding to this thickness of maximum anatomical region. Thus, a first setting point M of the detection sequence is fixed. Furthermore, a second point N is such that, for the mean EPT value, EPTmean, the gray level rendered by the detector is equal to a given proportion of the dynamic range. In one example, this proportion is 1/20th of the dynamic range. In practice, the correspondence for EPTmean is then that of the maximum gray level displayed multiplied by the given proportion, namely it is set at 800 gray levels in the example. Thus, the dynamic range ΔEPT is defined as the range preferably corresponding to the difference in equivalent thicknesses between the maximum anatomical thickness and the mean thickness. It could have been made to correspond to the difference between the mean thickness and the threshold thickness.

The following result (FIG. 2) is then obtained: in the region of interest ZI, tissues with little radiological differentiation are then rendered with the optimum contrast so that they can be distinguished and used by a practitioner.

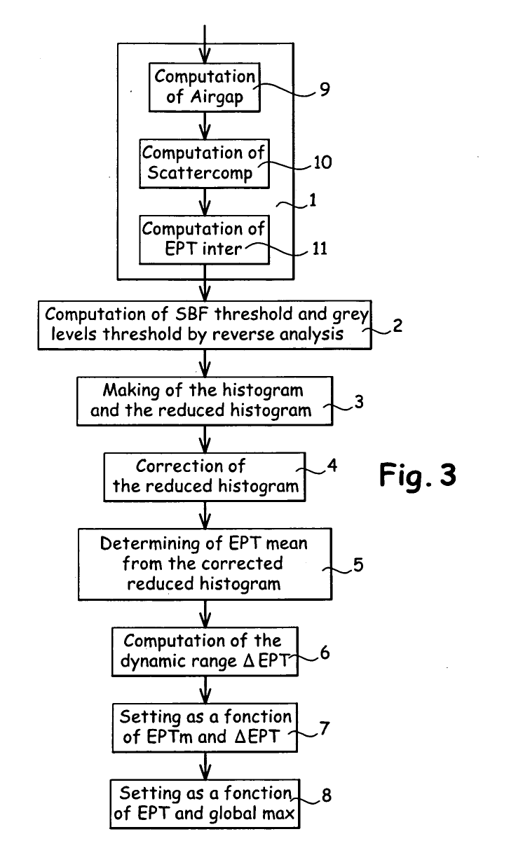

FIG. 3 shows a sequence of operations implemented in an information-processing device of the radiography installation of FIG. 1, not shown, in which all these operations are undertaken. FIG. 3 shows a first operation 1 at the end of which the threshold thickness S, below which the regions of the body C will be considered to be non-anatomical regions, will be determined. Step 1 is then followed by a step 2, examined further below, during which, for the conditions of acquisition of the test image, the dose corresponding to the threshold thickness S is computed along with the gray level of the threshold thickness, or preferably it is the gray level of the threshold thickness that is computed. During step 3, after the image is taken, the histogram shown in FIG. 1 is made along with the reduced histogram from which the pixels whose gray levels in practice are above a threshold are removed.

FIG. 4 shows a histogram that is real, in terms of number of pixels per gray level, and no longer simplistic like the one seen hitherto. The histogram of FIG. 4 shows that the level/level of the thickness threshold S can be found well beyond a real region of interest. FIG. 4 thus shows a part, corresponding to noise, located, in terms of thickness, between the threshold thickness S and the minimum thickness 1 of the tissues located in the region of interest ZI. The pixels concerned are considered to represent noise because the number of pixels concerned by each level is small therein and y is substantially constant.

Then, rather than limiting the operation to the elimination of the pixels whose level is higher than the level of the threshold S, there is also the removal, from the population that will be used to determine the mean thickness, of those of these pixels whose level is lower than the level of the thickness threshold, but which furthermore are close to it. Since it is sought to eliminate the level levels for which the occurrences are low, a totaled sum is set up of the occurrences of these noise-representing pixels shown in the hatched part of FIG. 4.

A determination is made of the minimum thickness 1 corresponding to the maximum anatomical thickness, by the subtraction of a certain predetermined number of totaled occurrences of level levels. This subtraction is done from the histogram measured between this threshold and this maximum anatomy. In one example, the integral is limited to 1024. Therefore, 1024 occurrences of level levels will be eliminated. However, it is possible to take a greater number, for example 10,000. As shown in FIG. 4 a search for a boundary line to the left of the boundary represented by the thickness threshold S decided here above.

FIG. 4 shows two types of tissues: a first tissue T1 for which the noise is of little importance, and a second tissue T2 shown with dashes for which the noise is very great. By deciding to remove a certain number of occurrences of level levels from the population of pixels that which will play a part in establishing the value of the mean thickness EPTmean, it is desirable to eliminate the pixels corresponding to noise, especially if the mean thickness, and therefore the useful region, has a far higher value (for example in the range of about 20 cm) as in this case with the dashed curve T2.

In FIG. 1, the point M has been set in taking account of the region of maximum anatomical thickness.

For the case T2 shown in dashes in FIG. 4, such a determination would have led to the shifting of the point M much further rightwards to M′. That is, it would have led to assigning of the dynamic range of the detector to far greater thicknesses without losing a major part of this dynamic range to show small thicknesses, which furthermore would have been determined as being of no interest since they represented only noise. In practice, almost linearly, the rightward shift of the point M will be accompanied by an increase in the high voltage in kilovolts supplied between the anode and the cathode of the tube T.

For the efficient performance of this optional search for the optimum anatomical thickness, after the step 3 a step 4 (FIG. 3) is shown. This is a step for the correction of the reduced histogram to take account of the maximum anatomical correction.

Step 4, which is not indispensable although it is desired, is followed by step 5 to determine the mean thickness from the reduced histogram, or preferably from the corrected reduced histogram. This determination, which will be described below, comprises a passage from the field of the level levels to the field of the thicknesses. Step 5 is followed by a step 6 during which the dynamic range ΔEPT is computed. The dynamic range is equal or, as stated here above, it corresponds to the mean thickness, EPTmean and the threshold thickness S, or better, the maximum anatomical corrected thickness threshold. Step 6 is followed by a known type of step 7 in which the installation is set as a function of l'EPTmean thus determined and of ΔEPT thus computed.

If the practitioner does not wish to benefit from the optimum setting thus obtained, but nevertheless desires the removal of the saturation regions, the same action is taken by eliminating all the level levels corresponding solely to the saturation from the histogram. In practice for example, all the pixels whose level levels correspond to saturation, 16384 pixels in the example, are eliminated along with all those contained in a level band comprising a certain number of gray levels, for example five gray levels. This band Bsat is also shown in FIG. 1. Thus, only the pixels whose gray levels range from 0 to 16379 will be taken into account. Then, while keeping the same mean equivalent patient thickness EPTmean, since EPTmean is an exact value, it can be chosen to set the dynamic range ΔEPT by choosing a point M″ instead of the point M. It is simply observed in examining FIG. 1, in this case, that if the mean thickness continues to be properly computed, the dynamic range is not as optimal. It makes it possible however to image the edge regions B of the patient without having to support the edge effect, forming borders in the images, whose presence may be troublesome in certain cases.

The determination of the threshold thickness S below which the contributions of the tissues are deemed to be of no interest, it desirable to take account of the geometry of acquisition of the installation at the time of acquisition of the first test image from which EPTmean and ΔEPT are determined. To this end, step 1 comprises a first step 9 during which a value AirGap of an airspace E is computed. The space E corresponds to the space located between the lower edge of the patient's body C and the anti-scatter grid GA. It will be understood that the greater this space the greater will be in the space of the image in which a marginal but nevertheless existing Compton scattering phenomenon will be propagated. The space E, with a value AirGap, is computed according to the following equation I:

$$AirGap = SID - IsoDistance\_ \frac{EPTthreshold}{2}$$

In equation II, SID represents the distance in centimeters from the X-ray source, the tube T, to the image, the plane of the detector D. The variable IsoDistance represents the distance between the lower edge of the patient's body and the X-ray source. In one example, corresponding to acquisition geometry of a known installation, this variable IsoDistance has a value of 70.5 cm. In practice, these values may be measured on the installation used, unless it is available in tables in recordings corresponding to states of use of the installation. The variable EPTthreshold divided by two corresponds to a purely arbitrary value, typically equal to 3 cm, because this value is known in the field. A value other than 3 cm could have been chosen. The value could depend on the place of examination in the body C. This value EPTthreshold corresponds to the equivalent thickness below which we can be sure that no interesting tissue is present. This approach to the value of the space E, independently of its significance in terms of length, is particularly useful for taking account of the harmful effects of the Compton scattering in the settings of the installation.

Step 1 comprises a step 10 to compute the value of a variable ScatterComp, representing the Compton scattering. Step 10 comprises the computation of the following equation II:

$$ScatterComp = [ \begin{matrix}sa + \\ ( sb \times EPTthreshold ) + \\ ( sc \times \sqrt{SurfaceFdbk} \times 10 ) + \\ ( sd \times AirGap ) + \\ ( se \times kVp\_actual ) + \\ ( sf \times {AirGap}^{2} ) + \\ ( sg \times EPTthreshold \times \sqrt{SurfaceFdbk} \times 10 ) + \\ ( sh \times EPTthreshold \times AirgGap ) + \\ ( si \times EPTthreshold \times kVp\_actual ) + \\ ( sj \times \sqrt{SurfaceFdbk} \times 10 \times AirGap ) + \\ ( sk \times \sqrt{SurfaceFdbk} \times 10 \times kVp\_actual ) + \\ ( sl \times AirGap \times kVp\_actual )\end{matrix} ]$$

In equation II, SurfaceFdbk represents, in cm², the surface area of the field of view FOV, and kVp_actual represents the high voltage with which the tube T was powered at the time of acquisition of the test image. The other variables are the ones seen above. The coefficients sa to sl is coefficients obtained by a regression operation. In practice, for a given installation, a large number of measurements are made on phantoms of known radiological densities, and the scattering variable Compton ScatterComp is also measured. The regression then consists in minimizing the determination of the twelve coefficients sa to sl for the batch of experiments conducted. In one example, these coefficients have the following given values in the following Table I:

TABLE I

| | Grid Case | No Grid case |
|---|---|---|
| Sa | −7.475555 | −2.553558 |
| Sb | 0.1502911 | −0.09362944 |
| Sc | −0.01001422 | −0.003292955 |
| Sd | 0.09967274 | −0.07583043 |
| Se | 0.07329555 | 0.05780994 |
| Sf | −2.78306E−05 | 0.002540896 |
| Sg | 0.000418987 | 0.000775114 |
| Sh | −0.001951803 | −0.004902506 |
| Si | −0.002153036 | −0.001676272 |
| Sj | 2.53236E−05 | −2.98979E−05 |
| Sk | 7.98413E−05 | 6.44851E−05 |
| Sl | −0.001169081 | −0.000729517 |

Table I comprises two columns representing the values of the coefficients sa to sl depending on whether a grid GA is present (Grid Case) or not (No Grid Case). The values present in the table II are not unique. The values depend on the installation. They may be recomputed by regression for each installation.

At this stage, it is possible, according to the following equation III corresponding to step 11 of step 1, to compute an intermediate variable EPTinter:

EPTinter=EPTthreshold−ScatterComp,

that is the equivalent thickness, now computed, that serves as a threshold of division between the thicknesses deemed to be significant and those that are not. It is possible to do without this computation and to determine a purely arbitrary value EPTinter that does not take account of the geometry of the installation and of the consequences of the Compton scattering. However, a less accurate determination of the threshold thickness is likely and hence a less accurate determination of EPTmean, and hence a sub-optimization of the setting of the installation.

Step 2 is implemented by the computation of the following equation IV:

SFBthreshold=exp(b₁₂+W₁₂·Φ(W₁₁·ln+b₁₁))

in which Φ is a function known as a Tansig function and is given by the following equation V:

Φ(x)=2/(l+e^{-2x})−1

In equation IV, the result SFBthreshold corresponds to the dose equivalent of the threshold thickness S that it was sought to choose for the elimination of the non-anatomical regions. Furthermore, if need be, another known type of conversion of SFBthreshold is performed to pass from a dose threshold to a gray level threshold. However, it is possible to work directly in terms of doses without going through the gray levels. The terms b of equation IV are vectors and the terms W are matrices. The dimensions of these vectors and these matrices are given by the following table II that, under the same conditions as those of the above Table I, pertain to a case where an anti-scatter grid is used (Grid Case) and a case where such a Grid is not used (No Grid case). The values indicated in the Table II are not unique. The values depend on the installation. They may be recomputed by regression for each installation.

TABLE II

| | |
|---|---|
| Grid Case | No Grid case |

b11

| | |
|---|---|
| −2.063206 | 1.141929e+000 |
| −1.691381 | −7.585333e+000 |
| 0.2518924 | 1.222830e−001 |
| 0.04235442 | −9.112446e−001 |

b12

| | |
|---|---|
| −87.533 | 1.307436e+000 |

W12

| | |
|---|---|
| −167.6873 | 2.193213e+000 |
| 69.62171 | 7.246941e−003 |
| −104.4955 | −4.693371e+001 |
| 546.7996 | −1.164029e+001 |

W11

| | | |
|---|---|---|
| column1 | 0.1941842 | −1.306519e+000 |
| column1 | 0.3070208 | 1.567155e+002 |
| column1 | −0.2290218 | 2.869121e−001 |
| column1 | −0.07949074 | −4.160542e−001 |
| column2 | −2.678886 | 8.710156e+000 |
| column2 | 1.037596 | −1.111888e+002 |
| column2 | −0.9156539 | −3.903610e−001 |
| column2 | −0.2088846 | 1.374886e+000 |
| column3 | −0.000354178 | −1.060510e−002 |
| column3 | 0.000655092 | −1.370747e+001 |
| column3 | 0.000405197 | −2.202027e−002 |
| column3 | 0.001881927 | 2.824983e−003 |
| column4 | 0.1541754 | −1.352894e+000 |
| column4 | 0.2825646 | 1.586209e+001 |
| column4 | −0.2311099 | 8.932972e−002 |
| column4 | −0.05804851 | −2.604596e−001 |
| column5 | 0.004109868 | −1.388468e−002 |
| column5 | 0.00886492 | 1.458186e+001 |
| column5 | −0.007394629 | 3.866862e−003 |
| column5 | −0.001900335 | −9.501290e−003 |

The term ln of equation IV is a 5D vector given by the following expression II:

ln=[Patient_size_normal, kVpnormal, mAnormal, cu_thickness_normal,al_thickness_normal]^{T}

In expression II Patient_size_normal=0.6*EPTinter. Furthermore, each “normal” value is preferably a standardized value corresponding to the following equation VI, where kVp normal is given by:

$$kVpnormal = \frac{kVp\_actual - kVp min}{kVp max - kVp min}$$

In equation VI, kVpmin and kVpmax are the minimum and maximum values of the use voltage, while kVp_actual represents the high voltage of installation under the conditions of the test image.

In expression II, mAbnormal is given by expression III:

$$mAnormal = log ( mAs\_actual \times \frac{{SID\_EPT}_{nn}^{2}}{{SID}^{2}} \times ( \frac{mr\_mas}{mr\_mas \_cal} ) )$$

In expression III, SID is the value of Source—to—Distance, SID_EPTnn is equal to 100 cm, mR_mAs_cal=4.0858, and mR_mAs is the calibrated value of mR/mAs

In this expression II, Cu_thickness_normal and Al_thickness_normal are given by the following equation VII:

$$filternormal ( 1 ) = \frac{Spectral\_Filter \_feedback ( thickness [ 1 ] - Spectral\_filter \_min [ 1 ]}{SpecrtalFilterMaxThickness [ 1 ] - Spectral\_filter \_min [ 1 ]}$$

The values of the filters Cu_lo, Cu_hi, Al_lo and Al_hi are respectively the minimum and maximum copper and aluminum thicknesses of filtration of the installation. The application of equation IV, shows that it is therefore possible to perform step 2, i.e., to compute the gray level corresponding to the threshold S solely from the setting parameters of the installation. In practice, this computation can be performed even before the image has been acquired and before its processing according to steps 3 and the steps that follow are undertaken to edit the values EPTmean and ΔEPT sought.

It is also desirable to transpose the above teaching to another installation. This transposition is made possible by modeling equation II for a given installation. This kind of modeling can be done by means of a neural network. More theoretically, conducting a large number of experiments does this kind of modeling. For these experiments, the input parameters In are made to vary and the received doses are measured correspondingly. Then, the error of computation of the correspondence between these doses and the input parameters is minimized, according to equation II, by searching for the components of the terms b and W which best satisfy this minimization. The model of equation IV is also known. It is a particular feature of an embodiment of the invention to use it in reverse.

The optimum parameters of the radiography acquisition are determined, and the settings of the installation are made, in real time. Once the coefficients of the Tables I and II, for a given installation have been acquired as a preliminary step, the optimum conditions for the setting of the installation are performed a few milliseconds after acquisition of the test image.

The embodiments of the method are preferably an automatic method. An embodiments of the invention is directed to a method for the setting of a radiology installation, especially a method for setting the high supply voltage for an X-ray tube of this installation, as well as the current of this tube, in order to make the acquisition with this installation. An embodiment of the invention is directed to achieving control over a dose of radiation emitted, and to heighten the contrast of an image acquired with such an installation, so that it reveals the structures to be examined with the utmost clarity.

An embodiment of the method is intended to be implemented before each acquisition, in real time, from a test image. In an embodiment of the method and in a first way, the mean thickness which is a piece of information for the setting of the installation is measured, as in the prior art, from a test image acquired with an X-ray installation working under known conditions of operation. However, in an embodiment of the invention, in this test image, pixels that do not represent significant anatomical parts of the patient are excluded. The non-significant parts include, firstly, the saturated part of the image. Typically, the saturated parts correspond to parts of the image located beyond the edge of the patient's body. However the non-significant parts may correspond to patient body thicknesses that are below a threshold. This threshold, to be determined, will be one below which it will be known that no anatomical structure is of any interest. In an embodiment of the method and in a second way, after this threshold has been determined, a difference between this threshold, expressed in terms of equivalent thickness, and the mean thickness of the patient's body, EPT mean, is chosen as the factor for fixing the dynamic range. This action gives a variable representing an objective measurement of the dynamic range of display to be chosen.

In an embodiment of the invention, the threshold thicknesses may themselves be corrected or not corrected to take account of certain disturbing phenomena, so as to increase the robustness with which the mean equivalent thickness or the dynamic range is determined.

An embodiment of the invention is directed to the making of the settings for an x-ray installation, particularly the setting for the high voltage applied between an anode and a cathode of an X-ray tube of this installation, this setting being a function of the mean thickness of a patient examined and being preferably made in real time, within a few seconds.

One skilled in the art may make or propose various modifications in structure and/or steps and/or function and/or way and/or result to the disclosed embodiments and equivalents thereof without departing from the scope and extent of protection.

What is claimed is:

1. A method to determine the optimal parameters of a radiography acquisition comprising:
a. a first test image of an object is acquired under known setting conditions for a radiography installation;
b. a mean thickness of the object is measured, for these known setting conditions, from the first test image test;
c. the optimal parameters of acquisition are determined from the mean thickness; and
d. a measure is made of the mean thickness from the first test image, where pixels that do not represent significant parts of the object are excluded from the first test image.

2. The method according to claim 1 wherein the radiology installation is set as a function of the optimal parameters wherein the high voltage applied between an anode and a cathode of an X-ray tube of the installation is set, the setting being done as a function of the mean thickness of the object examined.

3. The method according to claim 1 wherein in order to exclude the pixels, those pixels for which one characteristic in the image is located beyond a threshold are eliminated from the first image, the threshold corresponding to a borderline thickness of interest of the object; and below the borderline thickness, it is assumed that the image is of no interest and mean thickness is computed from a reduced histogram of pixels in which reduced histogram, the eliminated pixels are not present.

4. The method according to claim 2 wherein in order to exclude the pixels, those pixels for which one characteristic in the image is located beyond a threshold are eliminated from the first image, the threshold corresponding to a borderline thickness of interest of the object; and below the borderline thickness, it is assumed that the image is of no interest and mean thickness is computed from a reduced histogram of pixels in which reduced histogram, the eliminated pixels are not present.

5. The method according to claim 3 wherein the mean thickness value taken is the mean of the equivalent thicknesses corresponding to the pixels of the population of pixels of the reduced histogram.

6. The method according to claim 4 wherein the mean thickness value taken is the mean of the equivalent thicknesses corresponding to the pixels of the population of pixels of the reduced histogram.

7. The method according to claim 5 wherein:
a. a given number of pixels is subtracted from the population of pixels of the reduced histogram; and
b. the subtracted pixels are those whose equivalent thicknesses are the lowest from the threshold.

8. The method according to claim 6 wherein:
a. a given number of pixels is subtracted from the population of pixels of the reduced histogram; and
b. the subtracted pixels are those whose equivalent thicknesses are the lowest from the threshold.

9. The method according to claim 3 wherein for the setting of the installation, a pixel threshold is found for the test image by reverse analysis from the parameters for setting the installation, the pixel threshold being, for example, a gray level threshold or a dose threshold which corresponds to a thickness beyond which the tissue regions are deemed to be of no interest.

10. The method according to claim 5 wherein for the setting of the installation, a pixel threshold is found for the test image by reverse analysis from the parameters for setting the installation, the pixel threshold being, for example, a gray level threshold or a dose threshold which corresponds to a thickness beyond which the tissue regions are deemed to be of no interest.

11. The method according to claim 6 wherein for the setting of the installation, a pixel threshold is found for the test image by reverse analysis from the parameters for setting the installation, the pixel threshold being, for example, a gray level threshold or a dose threshold which corresponds to a thickness beyond which the tissue regions are deemed to be of no interest.

12. The method according to claim 7 wherein for the setting of the installation, a pixel threshold is found for the test image by reverse analysis from the parameters for setting the installation, the pixel threshold being, for example, a gray level threshold or a dose threshold which corresponds to a thickness beyond which the tissue regions are deemed to be of no interest.

13. The method according to claim 8 wherein for the setting of the installation, a pixel threshold is found for the test image by reverse analysis from the parameters for setting the installation, the pixel threshold being, for example, a gray level threshold or a dose threshold which corresponds to a thickness beyond which the tissue regions are deemed to be of no interest.

14. The method according to claim 9 wherein before the reverse analysis, the thickness is corrected as a function of an arbitrary thickness, a geometry of acquisition of the image and as a function of a Compton scattering phenomenon that results therefrom according to the following equations:
$$AirGap = SID - IsoDistance\_ \frac{EPTthreshold}{2}$$
$$and$$
$$ScatterComp = [ \begin{matrix}sa + \\ ( sb \times EPTthreshold ) + \\ ( sc \times \sqrt{SurfaceFdbk} \times 10 ) + \\ ( sd \times AirGap ) + \\ ( se \times kVp\_actual ) + \\ ( sf \times {AirGap}^{2} ) + \\ ( sg \times EPTthreshold \times \sqrt{SurfaceFdbk} \times 10 ) + \\ ( sh \times EPTthreshold \times AirgGap ) + \\ ( si \times EPTthreshold \times kVp\_actual ) + \\ ( sj \times \sqrt{SurfaceFdbk} \times 10 \times AirGap ) + \\ ( sk \times \sqrt{SurfaceFdbk} \times 10 \times kVp\_actual ) + \\ ( sl \times AirGap \times kVp\_actual )\end{matrix} ]$$

15. The method according to claim 10 wherein before the reverse analysis, the thickness is corrected as a function of an arbitrary thickness, a geometry of acquisition of the image and as a function of a Compton scattering phenomenon that results therefrom according to the following equations:
$$AirGap = SID - IsoDistance\_ \frac{EPTthreshold}{2}$$
$$and$$
$$ScatterComp = [ \begin{matrix}sa + \\ ( sb \times EPTthreshold ) + \\ ( sc \times \sqrt{SurfaceFdbk} \times 10 ) + \\ ( sd \times AirGap ) + \\ ( se \times kVp\_actual ) + \\ ( sf \times {AirGap}^{2} ) + \\ ( sg \times EPTthreshold \times \sqrt{SurfaceFdbk} \times 10 ) + \\ ( sh \times EPTthreshold \times AirgGap ) + \\ ( si \times EPTthreshold \times kVp\_actual ) + \\ ( sj \times \sqrt{SurfaceFdbk} \times 10 \times AirGap ) + \\ ( sk \times \sqrt{SurfaceFdbk} \times 10 \times kVp\_actual ) + \\ ( sl \times AirGap \times kVp\_actual )\end{matrix} ]$$

16. The method according to claim 11 wherein before the reverse analysis, the thickness is corrected as a function of an arbitrary thickness, a geometry of acquisition of the image and as a function of a Compton scattering phenomenon that results therefrom according to the following equations:
$$AirGap = SID - IsoDistance\_ \frac{EPTthreshold}{2}$$
$$and$$
$$ScatterComp = [ \begin{matrix}sa + \\ ( sb \times EPTthreshold ) + \\ ( sc \times \sqrt{SurfaceFdbk} \times 10 ) + \\ ( sd \times AirGap ) + \\ ( se \times kVp\_actual ) + \\ ( sf \times {AirGap}^{2} ) + \\ ( sg \times EPTthreshold \times \sqrt{SurfaceFdbk} \times 10 ) + \\ ( sh \times EPTthreshold \times AirgGap ) + \\ ( si \times EPTthreshold \times kVp\_actual ) + \\ ( sj \times \sqrt{SurfaceFdbk} \times 10 \times AirGap ) + \\ ( sk \times \sqrt{SurfaceFdbk} \times 10 \times kVp\_actual ) + \\ ( sl \times AirGap \times kVp\_actual )\end{matrix} ]$$

17. The method according to claim 12 wherein before the reverse analysis, the thickness is corrected as a function of an arbitrary thickness, a geometry of acquisition of the image and as a function of a Compton scattering phenomenon that results therefrom according to the following equations:
$$AirGap = SID - IsoDistance\_ \frac{EPTthreshold}{2}$$
$$and$$
$$ScatterComp = [ \begin{matrix}sa + \\ ( sb \times EPTthreshold ) + \\ ( sc \times \sqrt{SurfaceFdbk} \times 10 ) + \\ ( sd \times AirGap ) + \\ ( se \times kVp\_actual ) + \\ ( sf \times {AirGap}^{2} ) + \\ ( sg \times EPTthreshold \times \sqrt{SurfaceFdbk} \times 10 ) + \\ ( sh \times EPTthreshold \times AirgGap ) + \\ ( si \times EPTthreshold \times kVp\_actual ) + \\ ( sj \times \sqrt{SurfaceFdbk} \times 10 \times AirGap ) + \\ ( sk \times \sqrt{SurfaceFdbk} \times 10 \times kVp\_actual ) + \\ ( sl \times AirGap \times kVp\_actual )\end{matrix} ]$$

18. The method according to claim 13 wherein before the reverse analysis, the thickness is corrected as a function of an arbitrary thickness, a geometry of acquisition of the image and as a function of a Compton scattering phenomenon that results therefrom according to the following equations:
$$AirGap = SID - IsoDistance\_ \frac{EPTthreshold}{2}$$
$$and$$
$$ScatterComp = [ \begin{matrix}sa + \\ ( sb \times EPTthreshold ) + \\ ( sc \times \sqrt{SurfaceFdbk} \times 10 ) + \\ ( sd \times AirGap ) + \\ ( se \times kVp\_actual ) + \\ ( sf \times {AirGap}^{2} ) + \\ ( sg \times EPTthreshold \times \sqrt{SurfaceFdbk} \times 10 ) + \\ ( sh \times EPTthreshold \times AirgGap ) + \\ ( si \times EPTthreshold \times kVp\_actual ) + \\ ( sj \times \sqrt{SurfaceFdbk} \times 10 \times AirGap ) + \\ ( sk \times \sqrt{SurfaceFdbk} \times 10 \times kVp\_actual ) + \\ ( sl \times AirGap \times kVp\_actual )\end{matrix} ]$$

19. The method according to claim 9 wherein for the reverse analysis the result of the following equation is computed:
SFBthreshold=exp(b12+W12·Φ(W11·ln+b11))
wherein In represent the known conditions of setting of the installation, the values bij and Wij are respectively vectors and matrices, the values bij and Wij by learning, especially by minimization of an error in the computation of the equation for a set of thresholds, SFB threshold, and for a set of varied conditions of setting of the installation.

20. The method according to claim 10 wherein for the reverse analysis the result of the following equation is computed:
SFBthreshold=exp(b12+W12·Φ((W11·ln+b11))
wherein In represent the known conditions of setting of the installation, the values bij and Wij are respectively vectors and matrices, the values bij and Wij by learning, especially by minimization of an error in the computation of the equation for a set of thresholds, SFB threshold, and for a set of varied conditions of setting of the installation.

21. The method according to claim 11 wherein for the reverse analysis the result of the following equation is computed:
SFBthreshold=exp(b12+W12·Φ((W11·ln+b11))
wherein In represent the known conditions of setting of the installation, the values bij and Wij are respectively vectors and matrices, the values bij and Wij by learning, especially by minimization of an error in the computation of the equation for a set of thresholds, SFB threshold, and for a set of varied conditions of setting of the installation.

22. The method according to claim 12 wherein for the reverse analysis the result of the following equation is computed:
SFBthreshold=exp(b12+W12·Φ((W11·ln+b11))
wherein In represent the known conditions of setting of the installation, the values bij and Wij are respectively vectors and matrices, the values bij and Wij by learning, especially by minimization of an error in the computation of the equation for a set of thresholds, SFB threshold, and for a set of varied conditions of setting of the installation.

23. The method according to claim 13 wherein for the reverse analysis the result of the following equation is computed:
SFBthreshold=exp(b12+W12·Φ((W11·ln+b11))
wherein In represent the known conditions of setting of the installation, the values bij and Wij are respectively vectors and matrices, the values bij and Wij by learning, especially by minimization of an error in the computation of the equation for a set of thresholds, SFB threshold, and for a set of varied conditions of setting of the installation.

24. The method according to claim 14 wherein for the reverse analysis the result of the following equation is computed:
SFBthreshold=exp(b12+W12·Φ((W11·ln+b11))
wherein In represent the known conditions of setting of the installation, the values bij and Wij are respectively vectors and matrices, the values bij and Wij by learning, especially by minimization of an error in the computation of the equation for a set of thresholds, SFB threshold, and for a set of varied conditions of setting of the installation.

25. The method according to claim 15 wherein for the reverse analysis the result of the following equation is computed:
SFBthreshold=exp(b12+W12·Φ((W11·ln+b11))
wherein In represent the known conditions of setting of the installation, the values bij and Wij are respectively vectors and matrices, the values bij and Wij by learning, especially by minimization of an error in the computation of the equation for a set of thresholds, SFB threshold, and for a set of varied conditions of setting of the installation.

26. The method according to claim 16 wherein for the reverse analysis the result of the following equation is computed:
SFBthreshold=exp(b12+W12·Φ((W11·ln+b11))
wherein In represent the known conditions of setting of the installation, the values bij and Wij are respectively vectors and matrices, the values bij and Wij by learning, especially by minimization of an error in the computation of the equation for a set of thresholds, SFB threshold, and for a set of varied conditions of setting of the installation.

27. The method according to claim 17 wherein, for the reverse analysis the result of the following equation is computed:
SFBthreshold=exp(b12+W12·Φ((W11·ln+b11))
wherein In represent the known conditions of setting of the installation, the values bij and Wij are respectively vectors and matrices, the values bij and Wij by learning, especially by minimization of an error in the computation of the equation for a set of thresholds, SFB threshold, and for a set of varied conditions of setting of the installation.

28. The method according to claim 18 wherein for the reverse analysis the result of the following equation is computed:
SFBthreshold=exp(b12+W12·Φ((W11·ln+b11))
wherein In represent the known conditions of setting of the installation, the values bij and Wij are respectively vectors and matrices, the values bij and Wij by learning, especially by minimization of an error in the computation of the equation for a set of thresholds, SFB threshold, and for a set of varied conditions of setting of the installation.

29. The method according to claim 3 wherein to make the settings for the installation, the dynamic range of a detector of the installation is secured in such a way that a given proportion of a maximum of the dynamic range corresponds to a slice of equivalent thickness, the section being included between the mean thickness of the object and a thickness corresponding to the threshold.

30. The method according to claim 5 wherein to make the settings for the installation, the dynamic range of a detector of the installation is secured in such a way that a given proportion of a maximum of the dynamic range corresponds to a slice of equivalent thickness, the section being included between the mean thickness of the object and a thickness corresponding to the threshold.

31. The method according to claim 7 wherein to make the settings for the installation, the dynamic range of a detector of the installation is secured in such a way that a given proportion of a maximum of the dynamic range corresponds to a slice of equivalent thickness, the section being included between the mean thickness of the object and a thickness corresponding to the threshold.

32. The method according to claim 9 wherein to make the settings for the installation, the dynamic range of a detector of the installation is secured in such a way that a given proportion of a maximum of the dynamic range corresponds to a slice of equivalent thickness, the section being included between the mean thickness of the object and a thickness corresponding to the threshold.

33. The method according to claim 14 wherein to make the settings for the installation, the dynamic range of a detector of the installation is secured in such a way that a given proportion of a maximum of the dynamic range corresponds to a slice of equivalent thickness, the section being included between the mean thickness of the object and a thickness corresponding to the threshold.

34. The method according to claim 19 wherein to make the settings for the installation, the dynamic range of a detector of the installation is secured in such a way that a given proportion of a maximum of the dynamic range corresponds to a slice of equivalent thickness, the section being included between the mean thickness of the object and a thickness corresponding to the threshold.

35. The method according to claim 3 wherein to make the settings for the installation, the dynamic range of a detector of the installation is secured in such a way that a given proportion of a maximum of the dynamic range corresponds to a slice of equivalent thickness, the section being included between the mean thickness of the object and a thickness of the object that is the finest thickness yet visible in the image before saturation.

36. The method according to claim 5 wherein to make the settings for the installation, the dynamic range of a detector of the installation is secured in such a way that a given proportion of a maximum of the dynamic range corresponds to a slice of equivalent thickness, the section being included between the mean thickness of the object and a thickness of the object that is the finest thickness yet visible in the image before saturation.

37. The method according to claim 7 wherein to make the settings for the installation, the dynamic range of a detector of the installation is secured in such a way that a given proportion of a maximum of the dynamic range corresponds to a slice of equivalent thickness, the section being included between the mean thickness of the object and a thickness of the object that is the finest thickness yet visible in the image before saturation.

38. The method according to claim 9 wherein to make the settings for the installation, the dynamic range of a detector of the installation is secured in such a way that a given proportion of a maximum of the dynamic range corresponds to a slice of equivalent thickness, the section being included between the mean thickness of the object and a thickness of the object that is the finest thickness yet visible in the image before saturation.

39. The method according to claim 14 wherein to make the settings for the installation, the dynamic range of a detector of the installation is secured in such a way that a given proportion of a maximum of the dynamic range corresponds to a slice of equivalent thickness, the section being included between the mean thickness of the object and a thickness of the object that is the finest thickness yet visible in the image before saturation.

40. The method according to claim 19 wherein to make the settings for the installation, the dynamic range of a detector of the installation is secured in such a way that a given proportion of a maximum of the dynamic range corresponds to a slice of equivalent thickness, the section being included between the mean thickness of the object and a thickness of the object that is the finest thickness yet visible in the image before saturation.

41. A radiography comprising means for carrying out the method according to claim 1.

42. A computer program comprising code means that when executed on a computer carry out all of the steps of claim 1.

43. A computer program on a carrier carrying code that when executed on a computer carry out all of the steps of claim 1.

44. An article of manufacture for use with a computer system, the article of manufacture a comprising computer readable medium having computer readable program code means embodied in the medium, the program code means implementing the steps of the method according to claim 1.
